(19) United States
(12) Patent Application Publication
(10) Pub. No.: US 2023/0278310 A1
(43) Pub. Date: Sep. 7, 2023

(54) SUSTAINABLY MANUFACTURED MULTILAYER TUBE

(71) Applicant: TI Automotive (Fuldabrück) GmbH, Fuldabruck (DE)

(72) Inventors: André HÄCKEL, Waldeck (DE); Frank FAHRENHOLZ, Kassel (DE); Martin SCHRAMOWSKI, Kassel (DE); Siegfried ARNOLD, Kassel (DE)

(21) Appl. No.: 18/116,198

(22) Filed: Mar. 1, 2023

(30) Foreign Application Priority Data
Mar. 2, 2022 (EP) 22159654.7

(51) Int. Cl. B32B 1/08; F16L 11/10; B32B 27/08; B32B 27/34; B32B 7/12

(52) U.S. Cl. CPC B32B 1/08; F16L 11/10; B32B 27/08; B32B 27/34; B32B 7/12; B32B 2305/70; B32B 2307/404; B32B 2307/732; B32B 2307/202; B32B 2457/10; B32B 2274/00; B32B 2272/00

(57) ABSTRACT

A first plastic recyclate is used for a tube of a land vehicle, in particular of a road vehicle. The tube comprises a first layer and a second layer, wherein the first layer and the second layer abut against each other. The first layer has the first plastic recyclate, wherein the second layer comprises a first virgin plastic. The first plastic recyclate and the first virgin plastic belong to the same plastic species, for example to the plastic species of polyamides or the plastic species of polyolefins.

### RELATED APPLICATIONS

The present disclosure claims priority to and the benefit of European Application 22159654.7, filed on Mar. 2, 2022, the entire contents of each of which are incorporated herein by reference.

### FIELD

The disclosure relates to the use of a sustainably manufactured multilayer tube for a land vehicle, in particular for a road vehicle, wherein the tube has a first layer and a second layer, wherein the first layer and the second layer abut against each other.

### BACKGROUND

Fuel tanks for which a plastic recyclate is used are already known from DE 10 2016 226 064 A1. As a consequence, the wall of the fuel tank comprises several layers of varying thermoplastics, such as high density polyethylene (HDPE), low density polyethylene (LDPE) and ethylene-vinyl alcohol copolymer (EVOH). One exemplary layer sequence of the tank wall from the inside out is HDPE/LDPE/EVOH/LDPE/recyclate/HDPE. Plastic wastes accumulate during the use of extrusion blow molding for manufacturing the multilayer fuel tank, and are referred to in their entirety as slugs below. Therefore, the slug is a correspondingly proportionate mixture of the plastics HDPE, LDPE and EVOH. HDPE here makes up approx. two thirds, and LDPE approx. one third of the weight share, while EVOH makes up a weight share in the single digit percentage range or below due to the small layer thickness in the tank wall.

According to DE 10 2016 226 064 A1, the slug is ground into granules, and fed back into the process as a plastic recyclate by arranging the plastic recyclate as a separate layer in the tank wall. The recyclate layer makes up more than half the weight share of the fuel tank due to the comparatively large amount of production-related plastic waste. The use of recyclate makes the manufacturing process significantly more sustainable.

The disadvantage to the known plastic tanks with recyclate is that the conditions existing there for the layers cannot be transferred to tubes. In particular, the walls of tubes as a rule are significantly thinner than those of tanks, because the tubes have to be bent more strongly at numerous locations given the space conditions in motor vehicles. As a result, the layers of tubes must be synchronized much more precisely, because each layer must achieve the largest possible effect with the smallest possible wall thickness. Another reason why the conditions lack transferability is that the tanks are manufactured completely differently than the tubes. The tubes are extruded continuously instead of piece by piece, like tanks by way of extrusion blow molding.

Known from WO 2017/220657 A1 are tubes that comprise an inner, virgin HDPE layer, an outer, virgin HDPE layer, as well as a middle layer made of an HDPE recyclate. In this case, the HDPE recyclate does not originate from industrial waste, but rather from consumer waste, which is often much less clean. The tubes have a wall thickness of 5 mm and a diameter of 110 mm, and are thus many times larger than those of land vehicles. For example, the tubes known from WO 2017/220657 A1 can be suitable for transporting wastewaters, and are hence subject to modest requirements.

However, the framework conditions placed on tubes of land vehicles are in many respects much stricter than for sewage tubes. Tubes of land vehicles must have a very compact design, and be routed through the narrow space of a land vehicle with the help of numerous bends. Many tubes of land vehicles must simultaneously withstand very high pressures and/or temperatures, as well as adverse environmental influences. Finally, many of the tubes of land vehicles must offer a very low permeability with the help of barrier layers specially tailored to the corresponding, often aggressive fluids.

These technical requirements combined with the known cost pressure in the automobile supply industry lead to tube constructs that are extremely well differentiated and thought out in every detail, which is rather often reflected in the high number of five, six or even seven layers of a tube wall. The tube known from WO 2017/220657 A1 cannot be used in land vehicles, because it is unsuitable not only in terms of dimensions, but rather in particular also in terms of the used material (exclusively the standard plastic HDPE). In order to be able to satisfy the aforementioned requirements, at least several of the tube layers must have a technical plastic or a high-performance plastic.

### BRIEF SUMMARY

Therefore, the object of the disclosure is to create a tube for use in land vehicles, wherein the tube originates from a more sustainable manufacturing process, and can simultaneously satisfy the numerous technical requirements.

The aforementioned object is achieved by using a first plastic recyclate for a tube of a land vehicle, in particular of a road vehicle, wherein the tube comprises a first layer and a second layer, wherein the first layer and the second layer abut against each other, wherein the first layer has the first plastic recyclate, wherein the second layer comprises a first virgin plastic, wherein the first plastic recyclate and the first virgin plastic belong to the same plastic species, for example the plastic species polyamide or the plastic species polyolefin.

The disclosure is based upon the knowledge that the first plastic recyclate exhibits an adhesive behavior quite similar to the first virgin plastic of the same plastic species, despite the contamination or reuse. For this reason, the basic layer sequence of a tube without recyclate can only be enhanced by the recyclate layer, so that adjustments are less often required. To this end, the virgin layer to be partially replaced is thinner in design and enhanced by the recyclate layer. The recyclate layer or the first layer with the plastic recyclate will adhere very well to the first virgin plastic of the second layer and, in the case of a third layer on the opposite side, possibly also correspondingly well to the third layer.

It was further found that, by comparison to a corresponding virgin plastic, the recyclate often only satisfies the specifications with regard to mechanical and/or barrier properties only in part or not at all, so that it cannot completely displace the virgin plastic. For this reason, the disclosure is based in particular on the knowledge that the first virgin plastic continues to be necessary to be able to completely perform the respectively intended function of this layer, and not to excessively increase the wall thickness. Nevertheless, a good portion of virgin plastic is economized, so that the tube according to the disclosure originates from a more sustainable production, and simultaneously does not have to suffer any losses in quality. As a result, the object according to the disclosure is thereby achieved.

The term “recyclate” preferably refers to plastics which have already gone through a manufacturing process, during which the plastic material assumed a form provided for the (end) user. For example, this case can involve extruded or injection molded products or semifinished products, or a material that constitutes rejects during the manufacturing process. In the prior art DE 10 2016 226 064 A1 mentioned at the outset, production is designed in such a way that products are manufactured out of the virgin plastic and plastic waste accumulates. While the former are supplied to the market or the consumer, and run through a consumption cycle, this does not apply to the latter. The plastic waste can be supplied to this manufacturing process or some other manufacturing process practically immediately after accumulated. As a general rule, the plastic waste from the manufacturing process is much purer than those plastic materials that have gone through a complete consumer cycle. The term “recyclate” preferably only refers to plastic waste from industrial manufacture or industrial recyclate (postindustrial recyclate). However, the term “recyclate” can also encompass recyclate from end users (post-consumer recyclate), for example which is obtained from species- or type-pure materials of the “Yellow Bag” recycling system.

In terms of physical aspects, the plastics can be divided the plastic groups of thermoplastics, thermosets, and elastomers. Furthermore, additional plastic groups can be defined that combine properties of both groups. The thermoplastic elastomer plastic group is one example. The plastic groups can in turn be divided into subgroups with amorphous or (at least) partially crystalline plastic species. Among other things, the plastic groups of thermoplastics comprise the plastic species of polyamide (PA), that of polyolefins (PO), or that of polymers with vinyl alcohol (VA). The plastic species of polyamide comprises the plastic grades of aliphatic polyamides, aromatic polyamides (aramides), as well as those of the partially aromatic polyamides. For example, the plastic species of polyolefins comprises the plastic grades polypropylene (PP) and polyethylene (PE). For example, the plastic species of polymers with vinyl alcohol comprises the plastic grade of polyvinyl alcohols (PVOH) and the plastic grade of ethylene-vinyl alcohol copolymers (EVOH).

For example, the plastic grade of aliphatic polyamides comprises the plastic types PA6 or PA11. For example, the plastic grade of partially aromatic polyamides (polyphthalamides) comprises the plastic type PA9T. For example, the plastic grade polypropylene comprises the plastic type isotactic polypropylene. For example, the plastic type HDPE belongs to the plastic grade polyethylene. Various plastic types each distinguished by a varying hydrolyzation degree belong to the plastic grade PVOH. The plastic grade EVOH comprises various plastic types as a function of the ethylene share in mol. %.

Among other things, the plastic group of thermoplastic elastomers comprises the plastic species of thermoplastic vulcanizates (TPV). A plastic grade of thermoplastic vulcanizates is the EPDM/PP matrix, better known by the brand name Santoprene. The plastic grade of the EPDM/PP matrix comprises a plurality of plastic types, wherein each of these plastic types is characterized by a specific weight composition of EPDM and PP. Among other things, the plastic group of elastomers comprises the plastic species of ethylene-propylene copolymers (E/P). For example, the plastic species of the E/P rubbers has the plastic species ethylene-propylene-diene rubber (EPDM). The plastic species EPDM comprises a series of plastic types, which are characterized by respective specific weight shares of ethylene and diene.

The aforementioned examples illustrate the classification of the terms “plastic types”, “plastic grades” and “plastic species”. Plastic types are plastics with clearly defined properties, whereas the plastic grade constitutes the closest generic term of the plastic types. In turn, the plastic species is the respective closest generic term of the plastic grades.

The plastic species of the first plastic recyclate and the first virgin plastic is preferably selected from a quantity of plastic species comprising polyamides, polyolefins, polyurethanes, polymers with vinyl alcohol, fluoropolymers, thermoplastic vulcanizates, urethane-based thermoplastic elastomers, olefin-based thermoplastic elastomers.

According to a very especially preferred embodiment, the first plastic recyclate and the first virgin plastic belong to the same plastic grade, and preferably to the same plastic type. This achieves the object mentioned at the outset in an especially satisfactory manner. In practice, the preconception exists that plastics of the same plastic species, in particular of the same plastic grade as two different aliphatic polyamides, for example, can be used without any problem for the first layer and the second layer. One example would be a tube with a first layer that has a PA12 recyclate. A second layer of this exemplary tube from practice can comprise a virgin PA612 plastic. The idea of having the most identical materials possible for the first layer and the second layer has up to now been completely alien to practice. Instead, the aim is to combine polyamides of any kind with each other into layered composites. The background to this may be that polyamides are very often used with the most frequently employed technical plastics, and simultaneously in multilayer tubes. This makes the use of PA recyclates in multilayer tubes especially inexpensive. However, this obscures the fact that this cost aspect runs counter to various technical considerations, in particular having to do with the least possible number of layers, the thickness of the tube wall, and functionality. By contrast, the disclosure is based in particular on the knowledge that, while using PA12 recyclate in the first layer and a virgin PA612 plastic in the second layer does achieve the object mentioned at the outset, it is still remains fraught with disadvantages. For example, this combination, which replaces a previous, single layer of PA612, often requires having to adjust a layer that lies opposite the PA612 layer and adjoins the PA12 recyclate layer to the PA12 recyclate layer.

Very particularly, it was found that an adjustment of the opposing layer can be omitted or completely eliminated if the first plastic recyclate and the first virgin plastic belong to the same plastic grade, and preferably to the same plastic type. In particular, in virtually no case would an adhesion promoting layer be required, which would otherwise in some instances have to be arranged between the first layer and a layer lying opposite the second layer. At the same time, the first layer replaces portions of the previous, virgin layer as best as possible, thereby making the combined thickness of the first and second layer, and hence also the thickness of the tube wall, as low as possible.

According to an especially preferred embodiment, the share of the layer thickness of the first layer in relation to the combined total thickness of the first layer and the second layer measures at most 95% or 90% or 85% or 80% or 75% or 70%. It is expedient that the share of the layer thickness of the second layer in relation to the combined total thickness of the first layer and the second layer amount to at least 5% or 10% or 15% or 20% or 25% or 30%. The share of the layer thickness of the first layer in relation to the combined total thickness of the first layer and the second layer advantageously amounts to at least 30% or 40% or 50% or 60% or 70%. It is preferred that the share of the layer thickness of the second layer in relation to the combined total thickness of the first layer and the second layer amount to at most 70% or 60% or 50% or 40% or 30%. It was found that the second layer cannot be abandoned altogether when using a first layer comprising the first plastic recyclate. Therefore, the object mentioned at the outset is especially preferably achieved by the mentioned layer thickness ratios. This is a surprising realization, for example since it would have been readily conceivable that a virgin layer be replaced entirely by a somewhat thicker recyclate layer. This is not the case, however, so that in particular the mentioned, preferred layer thickness ratios represent especially advantageous technical solutions.

A layer thickness of the second layer advantageously amounts to at most 0.7 mm or 0.6 mm or 0.5 mm or 0.4 mm or 0.35 mm. It is preferred that the second layer have a layer thickness of at least 0.05 mm or 0.07 mm or 0.09 mm. A layer thickness of the first layer preferably measures at least 0.2 mm or 0.3 mm or 0.4 mm. A layer thickness of the first layer can amount to at most 1.5 mm or 1.2 mm or 1.0 mm or 0.8 mm or 0.6 mm.

According to a preferred embodiment, the layer thickness of the first layer measures at least 10% or 15% or 20% in relation to the total wall thickness of the tube. The layer thickness of the first layer expediently amounts to at most 70% or 60% or 50% or 40% of the total wall thickness of the tube.

The molar mass distribution of the first plastic recyclate or the first layer is expediently broader than that of the first virgin plastic and/or the second layer. Expressed differently, it is expedient that the polydispersity of the molar mass distribution of the first plastic recyclate or the first layer be greater than that of the first virgin plastic and/or the second layer. It is possible that the molar mass distribution of the first plastic recyclate be bimodal or multimodal. Therefore, it is possible for the molar mass distribution of the first plastic recyclate to have several maxima. In this case, the term “polydispersity” is preferably to be understood to mean that the individual polydispersities of the individual maxima are added together, provided that the polydispersities of the individual maxima do not overlap. By contrast, if the polydispersities of the individual maxima do overlap, the lowest and highest limit value of the overlapping polydispersities are subtracted from each other, so as to determine the resultant overlap polydispersity. It is especially preferred that the polydispersity of the molar mass distribution of the first plastic recyclate exceed that of the first virgin plastic by at least a factor of 1.1 or 1.2 or 1.3 or 1.4 or 1.5 or 1.6.

The percentage by weight of the first plastic recyclate in the first layer advantageously measures at least 70% or 80% or 90% or 95% or 97% or 99%. It is possible that the percentage by weight of the first virgin plastic in the second layer measure at least 70% or 80% or 90% or 95% or 97% or 99%. It is preferred that the remaining weight share of the first layer or the second layer comprise at least 50% or 70% or 90% additives. It is very preferred that the first layer and/or the second layer comprise no additional plastic.

It is possible that the first layer have a darker color than the second layer. This can result from the use of recycled materials, which as a whole are frequently somewhat less pure than the virgin materials. It might be that the first layer has a shade—in particular a gray shade—which is located in the darker half, and in particular in the darker third of an accompanying color table. The second layer advantageously has a shade that is in the brighter half or in the brighter third of an accompanying color table. It is very preferred that the color of the first layer be at least gray, preferably dark gray, and especially preferably black. The second layer advantageously has a white shade. In one embodiment, the first layer comprises a pigment, wherein the pigment is allocated to a darker third of an accompanying color table. It is possible that the first layer and/or second layer be white, in particular creamy white or grayish white, wherein the first layer expediently is darker than the second layer.

It is preferred that industrial plastic residues be used for the first plastic recyclate.

In a preferred embodiment, the first plastic recyclate and the first virgin plastic belong to the polyamides, the polyolefins, or the same plastic species from the plastic group of thermoplastic elastomers. The first plastic recyclate and the first virgin plastic preferably belong to the aliphatic polyamides. It is possible that the first plastic recyclate and the first virgin plastic belong to the plastic grade of polypropylene. The first plastic recyclate and the first virgin plastic preferably belong to the thermoplastic vulcanizates.

According to an advantageous embodiment, the tube has an additional layer, wherein the additional layer comprises a second virgin plastic, wherein the second virgin plastic belongs to the same plastic species, preferably to the same plastic grade, and especially preferably to the same plastic type as the first plastic recyclate. It is very preferred that the first layer be arranged between the second layer and the additional layer. The first layer especially preferably abuts against the additional layer. It is advantageous that the additional layer or the second virgin plastic share at least one feature, preferably several features, and very especially preferably all of the previously mentioned features in common with the second layer or the first virgin plastic. This arrangement is based upon the knowledge that an optimum functionality is achieved at the cost of three layers, wherein a significant portion of this three-layer structure simultaneously consists of recycled plastic. In particular, one advantage to the three-layer arrangement with a second virgin plastic is that the first layer with the first plastic recyclate is protected by the two layers with the virgin plastics. For example, the first layer can ensure a sufficient mechanical stability, while the second layer and the additional layer chemically protect the first layer.

It is possible that the tube comprise a further layer, wherein the further layer has a second plastic recyclate. The tube can comprise a second virgin layer, wherein the second virgin layer advantageously abuts against the further layer. The second virgin layer expediently comprises an additional virgin plastic. It is especially advantageous that the additional plastic belong to the same plastic species, preferably to the same plastic grade, and especially preferably to the same plastic type as the second plastic recyclate. The plastic species of the first plastic recyclate and the first virgin plastic is preferably selected from a number of plastic species comprising polyamides, polyolefins, polyurethanes, polymers with vinyl alcohol, fluoropolymers, thermoplastic vulcanizates, urethane-based thermoplastic elastomers, olefin-based thermoplastic elastomers. The second plastic recyclate can have one, several or all of the aforementioned features of the first plastic recyclate. The additional virgin plastic or the second virgin plastic can have one, several or all of the aforementioned features of the first virgin plastic or the second layer. It is possible that the tube comprise even more further layers. For example, these further layers can have a polyamide, a polyolefin or another of the aforementioned plastic species.

According to an embodiment, an adhesion-promoting layer abuts against the first layer. In particular, the adhesion-promoting layer can have a polyolefin. It is possible that the adhesion-promoting layer be a blend comprised of the first layer and an additional plastic, wherein the additional plastic is a component of the layer to be connected with the adhesion-promoting layer. It is possible that the adhesion-promoting layer comprise an additive that improves adhesion. For example, the adhesion-improving additive can be a maleic acid anhydride, a dimethyl maleate or acrylic acid.

The tube is preferably used in a land vehicle, and especially preferably in a road vehicle. The road vehicle is advantageously an electric vehicle. It is preferred that the tube be used as a cooling tube means. It is especially advantageous that the tube preferably employed as a cooling tube means be used for cooling purposes inside of an electric vehicle, in particular for cooling a battery of the electric vehicle. It is possible that the tube be used for transporting fuels and/or brake fluids and/or hydrogen and/or aqueous urea solutions and/or refrigerants for air conditioners.

### BRIEF DESCRIPTION OF THE DRAWINGS

The disclosure will be described in more detail below based upon four exemplary embodiments in four schematically designed figures. Shown on:

FIG. 1 is a first exemplary embodiment in cross section with five layers,

FIG. 2 is a second exemplary embodiment in cross section with six layers,

FIG. 3 is a third exemplary embodiment in cross section with five layers,

FIG. 4 is a fourth exemplary embodiment in cross section with six layers.

### DETAILED DESCRIPTION

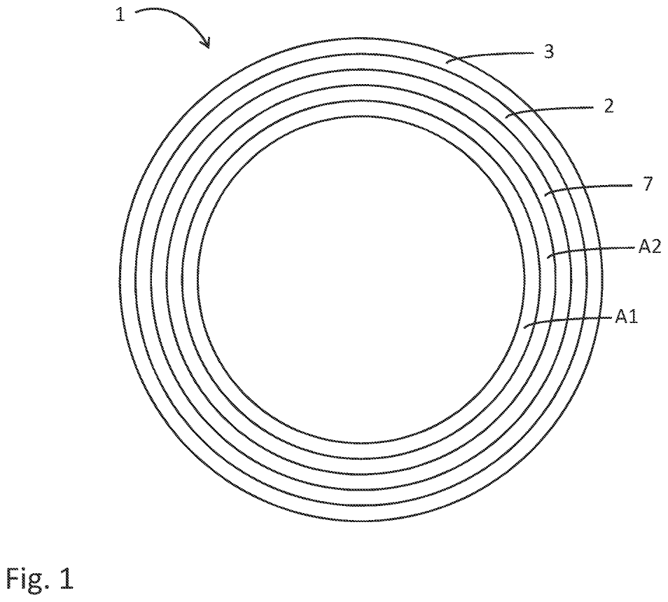

FIG. 1 shows a first exemplary embodiment of the disclosure in the form of a tube 1, which is illustrated in cross section. The tube 1 in this exemplary embodiment comprises a total of five layers. A first layer 2 comprises a first plastic recyclate, wherein the first plastic recyclate in this exemplary embodiment consists of PA12. The first layer 2 can be surrounded by a second layer 3, which comprises a first virgin plastic. The first virgin plastic of the second layer 3 in this exemplary embodiment consists of PA12. The first layer 2 in this exemplary embodiment encloses an adhesion-promoting layer 7 for optimized adhesion to a layer A2. For example, the layer A2 can have a polypropylene. The layer A2 can on its part enclose an innermost layer A1. For example, the innermost layer A1 can comprise a thermoplastic elastomer.

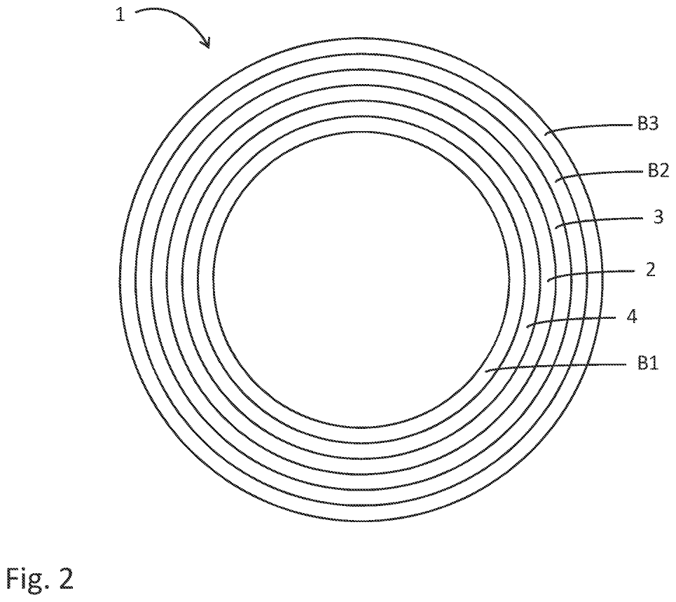

The tube 1 in the second exemplary embodiment according to FIG. 2 comprises a first layer 2, which has a first plastic recyclate. The first plastic recyclate in this exemplary embodiment preferably consists of a polypropylene, and especially preferably of an isotactic polypropylene. The tube 1 in the second exemplary embodiment comprises a second layer 3, which has a first virgin plastic. The first virgin plastic in this exemplary embodiment preferably consists of a polypropylene, and especially preferably of an isotactic polypropylene. In this exemplary embodiment, the second layer 3 is arranged around the first layer 2. The first layer 2 on its part encloses an additional layer 4. The additional layer 4 comprises a second virgin plastic, wherein the second virgin plastic in this exemplary embodiment consists of a polypropylene, in particular an isotactic polypropylene. Finally, the additional layer 4 can enclose an innermost layer B1, which preferably has a thermoplastic elastomer. It is possible that the second layer 3 be enclosed by a layer B2. The layer B2 in this exemplary embodiment can comprise an adhesion promoter. In this exemplary embodiment, an outermost layer B3 encloses the layer B2. The layer B3 can have a polyamide, in particular PA11 or PA12.

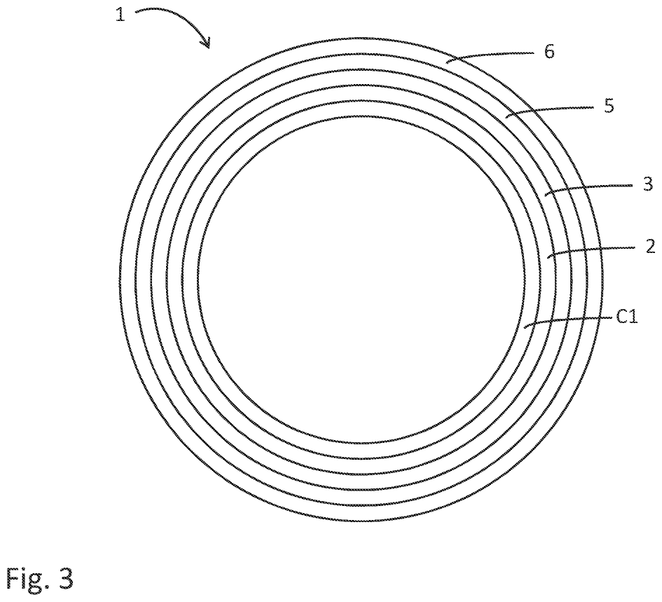

The third exemplary embodiment of a tube 1 illustrated on FIG. 3 comprises a total of five layers. A first layer 2 has a first plastic recyclate, which preferably consists of a polypropylene, in particular isotactic polypropylene. In this initial example, a second layer 3 encloses the first layer 2, and comprises a first virgin plastic. The first virgin plastic in this exemplary embodiment can consist of a polypropylene, in particular an isotactic polypropylene. It is possible that the second layer 3 be enclosed by a further layer 5. The further layer 5 preferably comprises a second plastic recyclate, which in this exemplary embodiment consists of a thermoplastic vulcanizate, preferably an EPDE/PP-based TPV. It is preferred that the further layer 5 be enclosed by a second virgin layer 6. The second virgin layer 6 advantageously comprises an additional virgin layer, which preferably consists of a thermoplastic vulcanizate, preferably an EPDM/PP-based TPV. In this third exemplary embodiment, the second virgin layer 6 forms the outermost layer of the tube 1. It is possible that the first layer 2 enclose an innermost layer C1. For example, the innermost layer C1 can have a thermoplastic vulcanizate.

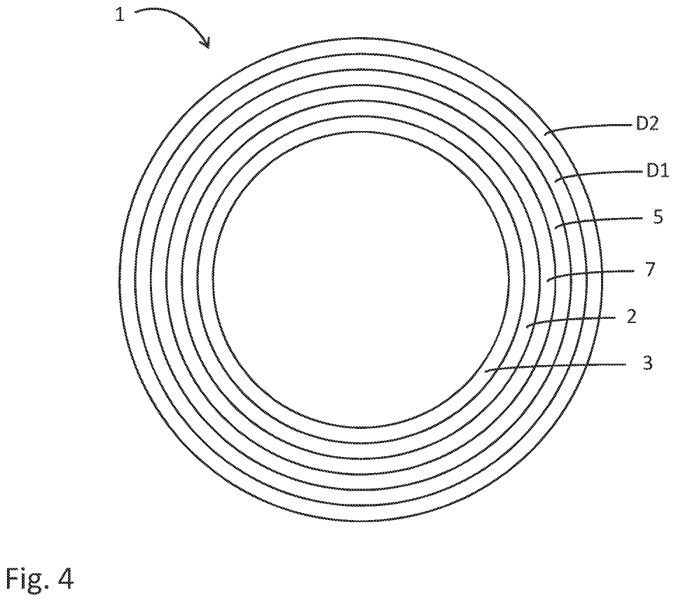

The fourth exemplary embodiment of the disclosure illustrated on FIG. 4 shows a tube 1 in cross section, which has a total of six layers. A first layer 2 comprises a first plastic recyclate, which in this exemplary embodiment comprises a thermoplastic elastomer. For example, the thermoplastic elastomer of the first layer 2 can be EPDM. In this exemplary embodiment, the first layer 2 encloses a second layer 3, which can at the same time also be the innermost layer. The second layer 3 can comprise a first virgin plastic, wherein the first virgin plastic is preferably a thermoplastic elastomer, and in particular an EPDM. In this exemplary embodiment, the first layer 2 is enclosed by an adhesion-promoting layer 7, which on its part is surrounded by a further layer 5. The further layer 5 preferably comprises a second plastic recyclate. The second plastic recyclate preferably consists of a thermoplastic vulcanizate. The further layer 5 is advantageously enclosed by a second virgin layer 6, wherein the second virgin layer 6 can have an additional virgin plastic. The additional virgin plastic preferably consists of a thermoplastic vulcanizate.

The exemplary embodiments enumerated above are preferably used for application in motor vehicles. The tubes 1 in the four mentioned exemplary embodiments are especially preferably used for transporting a coolant in a motor vehicle, so that cooling tubes are expediently involved. It is very preferred that the cooling tubes be used for cooling batteries in electric vehicles. For example, the cooling medium transported in the cooling tubes can be a water-glycol liquid.

1. Use of a first plastic recyclate for a tube of a land vehicle, wherein the tube comprises a first layer and a second layer, wherein the first layer and the second layer abut against each other, wherein the first layer has the first plastic recyclate, wherein the second layer comprises a first virgin plastic, wherein the first plastic recyclate and the first virgin plastic belong to the same plastic species.

2. The use according to claim 1, wherein the first plastic recyclate and the first virgin plastic belong to the same plastic grade.

3. The use according to claim 1, wherein the share of the layer thickness of the first layer in relation to the combined total thickness of the first layer and the second layer measures at most 90% or 80% or 75%.

4. The use according to claim 1, wherein the second layer has a layer thickness of at most 0.5 mm or 0.4 mm or 0.35 mm.

5. The use according to claim 1, wherein the layer thickness of the first layer measures at least 10% or 15% or 20% in relation to the total wall thickness of the tube.

6. The use according to claim 1, wherein the molar mass distribution of the first plastic recyclate or the first layer is broader than that of the first virgin plastic and/or the second layer.

7. The use according to claim 1, wherein the percentage by weight of the first plastic recyclate in the first layer measures at least 70% or 90% or 95%.

8. The use according to claim 1, wherein the percentage by weight of the first virgin plastic in the second layer measures at least 70% or 90% or 95%.

9. The use according to claim 1, wherein the first layer has a darker color than the second layer, wherein the first layer preferably has a gray shade which is located in the darker half of an accompanying color table.

10. The use according to claim 1, wherein industrial plastic residues are used for the first plastic recyclate.

11. The use according to claim 1, wherein the first plastic recyclate and the first virgin plastic belong to the plastics species of the polyamides, the polyolefins, or the plastics species of thermoplastic elastomers.

12. The use according to claim 1, wherein the tube has an additional layer, wherein the additional layer comprises a second virgin plastic, wherein the second virgin plastic belongs to the same plastic species as the first plastic recyclate.

13. The use according to claim 1, wherein the tube comprises a further layer, wherein the further layer has a second plastic recyclate.

14. The use according to claim 1, wherein the tube comprises a second virgin layer, wherein the second virgin layer has an additional virgin plastic.

15. The use according to claim 1, wherein the land vehicle is an electric vehicle, and wherein the tube is used as a cooling means for a battery of the electric vehicle.
